(19) United States
(12) Patent Application Publication
(10) Pub. No.: US 2002/0009247 A1
(43) Pub. Date: Jan. 24, 2002

(54) High-speed rolling bearing, in particular, angular ball bearing

(75) Inventors: Manfred Weck, Aachen (DE); Berthold Spechtel, Aachen (DE)

Correspondence Address: Gudrun E. Huckett, Ph.D., P.O. Box 3187, Albuquerque, NM, 87190-3187, US

(73) Assignee: Manfred Weck, Aachen (DE)

(21) Appl. No.: 09/858,159

(22) Filed: May 14, 2001

(30) Foreign Application Priority Data
May 26, 2000 (DE) 100 26 094.2

(51) Int. Cl. F16C 33/58

(52) U.S. Cl. 384/516

(57) ABSTRACT

A high-speed rolling bearing has an outer ring and an inner ring arranged inside the outer ring. Rolling bodies are positioned between the inner ring and the outer ring and contact the inner ring and the outer ring. The outer ring has two oppositely positioned contact points for each rolling body on which the rolling bodies are supported, respectively. The contact points are configured such that a contact angle of the rolling bodies is at least approximately independent of a rotational speed of a rotary part supported by the high-speed rolling bearing.

### BACKGROUND OF THE INVENTION

1. Field of the Invention

The invention relates to a high-speed rolling bearing, in particular, an angular ball bearing, comprising an outer ring and an inner ring and rolling bodies which contact the outer ring and the inner ring.

2. Description of the Related Art

It is conventional to employ angular ball bearings as rolling bearings for shafts and spindles which rotate at high-speeds. Such angular ball bearings are illustrated in FIGS. 1a, 1b and 2a, 2b. The angular ball bearings are adjusted in an O or X arrangement axially relative to one another. The contact angle of these angular ball bearings are between 15° and 25°. The angular ball bearings have an outer ring 1 and an inner ring 2. Between them, the rolling bodies 3 in the form of balls are positioned which are secured in a cage 4.

FIG. 1a shows the force interrelationships for the rolling contact of the known angular ball bearing for a low rotational speed of the shaft or spindle. The oppositely directed axial preload forces Fᵥ act onto the outer ring 1 and the inner ring 2. The resultant force Fₙ_{_{—}}ₙₗ acts on the rolling bodies 3 in the contact area of the outer ring 1, while at the oppositely positioned contact point of the inner ring 2 the normal force Fₙ acts on the rolling bodies 3 which is oriented opposite to the resultant normal force Fₙ_{_{—}}ₙₗ. With increasing rotational speed of the shaft or spindle, the following effects disadvantageously affect the inner load and thus the service life of the rolling bearing. Since the centrifugal forces acting on the roller bodies 3 as well as the expansion forces acting on the inner ring 2 increase by a quadratic function, the rolling balls 3 are deflected in the direction toward the apex 5 of the outer ring 1 (FIG. 1b). The same effect is caused by the increasing preload forces Fᵥ, which increase more than proportionally with increasing rotational speed of the shaft or spindle, as a result of the increasing temperature gradient between the shaft, i.e., the inner ring 2 seated fixedly thereon, and the housing, i.e., the outer ring 1 fastened thereto. The result of these inter-relationships is a drastic reduction of the contact angle or pressure angle and, going hand-in-hand therewith, a dramatic increase of the contact loading as a result of the preload forces Fᵥ and the outer loading. As is illustrated in FIG. 1b, the radial force F_{radial}_{_{—}}ₙₗₗ increases greatly which results in a very strong increase of the resulting normal force Fₙ_{_{—}}ₙₗₗ. Moreover, the expansion force F_{f} is also effective.

Also, with increasing rotational speed of the shafts and spindles, the kinematic conditions of the rolling contact of the balls 3 between the outer ring 1 and the inner ring 2 deteriorate. In FIG. 2a the spinning/rolling ratios of the inner ring 2 and the outer ring 1 are illustrated for low rotational speed of the shaft or spindle of the known angular ball bearing. FIG. 2b shows these ratios for high rotational speed of the shaft or spindle. It can be clearly seen that at a high rotational speed the spinning/rolling ratio at the inner ring 2 in comparison to the low rotational speed of the shaft or spindle (FIG. 2a) has increased greatly. The proportion of the spinning friction ω_{spin, i}, of the inner ring 2, which also increases wear and which determines the frictional loss and thus the temperature, also increases.

### SUMMARY OF THE INVENTION

It is an object of the present invention to develop a high-speed rolling bearing of the aforementioned kind such that the increasing rotational speed of the rotary part supported in the rolling bearing has no disadvantageous effects on the rolling bearing.

In accordance with the present invention, this is achieved in that, for the purpose of achieving a contact or pressure angle that is at least approximately independent of the rotational speed of a rotary part supported in the rolling bearing, the rolling bodies are supported on two oppositely positioned contact points of the outer ring, respectively.

In the high-speed rolling bearing according to the invention, the rolling bodies are supported on two oppositely positioned contact points of the outer ring. This has the result that the contact or pressure angles are at least approximately independent from the rotational speed and the inner preload forces, i.e., remain at least substantially constant. Since the rolling bodies are supported on the oppositely positioned contact points of the outer ring, a position of the ball races relative to the outer ring that is virtually rotational speed-independent and force-independent is obtained.

### BRIEF DESCRIPTION OF THE DRAWING

In the drawing:

FIG. 1a shows the force interrelationships of a prior art angular ball bearing for a low rotational speed of a supported shaft;

FIG. 1b shows the force interrelationships of the prior art angular ball bearing of FIG. 1a at high rotational speed of the supported shaft;

FIG. 2a shows the spinning/rolling ratios of the inner ring 2 and the outer ring 1 of the prior art angular ball bearing of FIG. 1a for low rotational speed of the shaft;

FIG. 2b shows the spinning/rolling ratios of the inner ring 2 and the outer ring 1 of the prior art angular ball bearing of FIG. 1a for high rotational speed of the shaft;

FIG. 3 illustrates the kinematic relations of a first embodiment of a high-speed rolling bearing according to the invention;

FIG. 4 shows in axial section a second embodiment of a high-speed rolling bearing according to the invention;

FIG. 5 is a perspective illustration and axial section of a portion of the high-speed rolling bearing according to FIG. 4

FIG. 6 shows in a representation corresponding to FIG. 5 the high-speed rolling bearing according to FIG. 3.

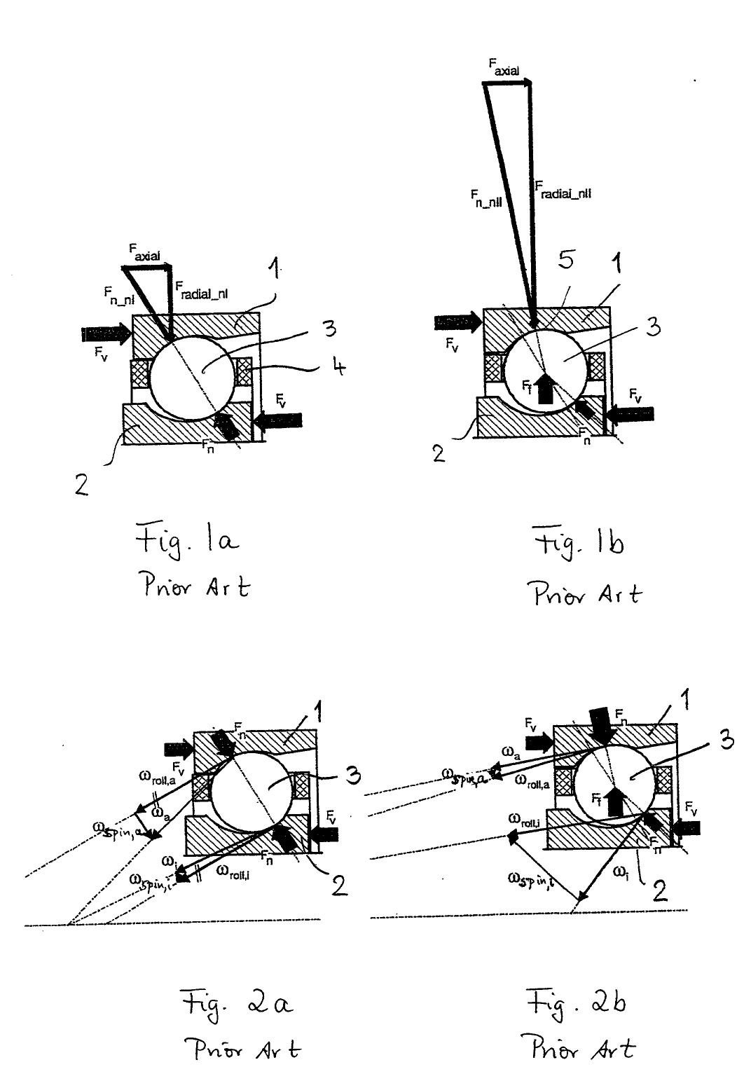

### DESCRIPTION OF THE PREFERRED EMBODIMENTS

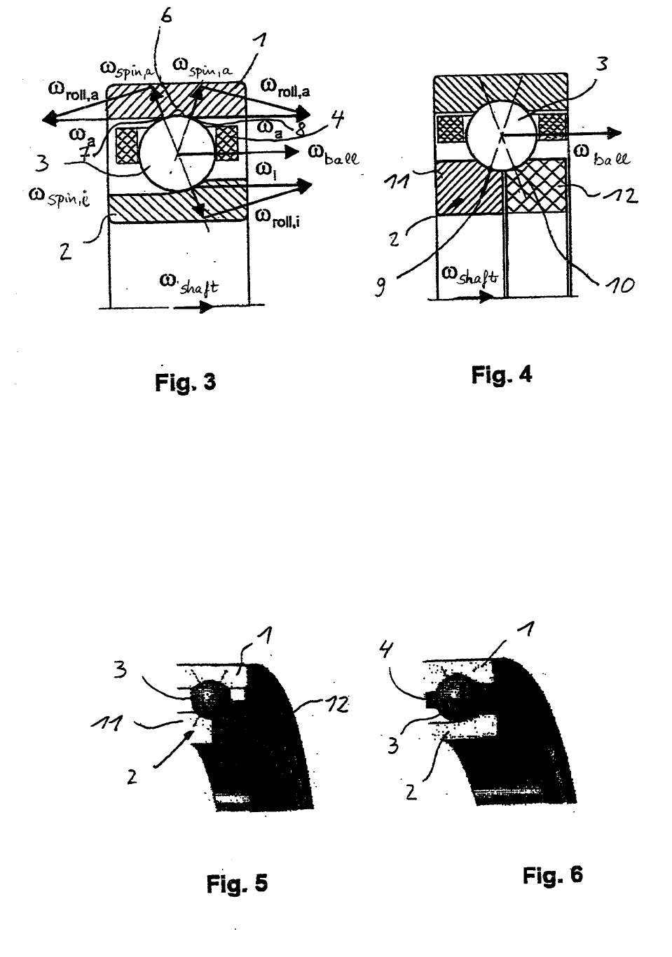

The high-speed rolling bearing according to FIGS. 3 and 6 comprises the outer ring 1, the inner ring 2, as well as the rolling bodies 3 in the form of rolling balls which are secured in the cage 4. The inner ring 2 is adjusted against the rolling bodies with one-sided contact. The outer ring 1 has at its inner surface a ball race 6 which is formed such that the rolling balls 3 are supported on two oppositely positioned contact points 7, 8 of the outer ring 1 wherein the contact or pressure angles at the inner and outer rings 2, 1 must not be identical. These spinning/rolling ratios at the outer ring will not change when the shaft or the spindle is driven at high rotational speed. In this way, an almost rotational speed-independent and force-independent position of the rolling bodies 3 relative to the outer ring 1 is obtained. The contact or engagement angles are designed according to the described geometry of the rolling bearing such that the contact or engagement angles are largely independent of the rotational speed and the preload forces, i.e., they remain constant.

Since the inner ring 2 is adjusted against the rolling bodies 3 with one-sided contact, the rolling bodies 3 are provided with a 3-point contact. In FIG. 3, the rotational speed ω_{shaft} of the shaft or spindle to be supported, the rotational speed ω_{ball} of the rolling bodies 3 as well as the rotational speeds ωₐ (outer ring 1) and ωᵢ (inner ring 2) resulting at the contact points of the rolling bodies 3 with the outer ring 1 and the inner ring 2 are illustrated.

The inner ring 2 can also be configured such (FIGS. 4 and 5) that it also contacts the rolling bodies 3 at two oppositely positioned contact locations 9, 10. The rolling bodies 3 are thus supported on four contact points/locations 7 through 10 so that this rolling bearing is a so-called “ball-4-spot” bearing. The two-point support of the rolling bodies 3 on the inner ring 2 is achieved in that the inner ring 2 is of a two-part configuration. This separation into two parts can be configured differently, for example, in the form of two symmetrical halves 11, 12 as illustrated in FIG. 4. The contact locations 9, 10 are provided accordingly on the inner ring half 11 and the inner ring half 12, respectively. This configuration of the rolling bearing provides for an axial force introduction in both axial directions. In other respects, this rolling bearing is of the same configuration as the embodiment according to FIGS. 3 and 6.

The described rolling bearings are excellently suitable as high-speed rolling bearings as a result of the described favorable kinematic conditions and load conditions.

While specific embodiments of the invention have been shown and described in detail to illustrate the inventive principles, it will be understood that the invention may be embodied otherwise without departing from such principles.

What is claimed is:

1. A high-speed rolling bearing comprising:
an outer ring (1) and an inner ring (2) arranged inside said outer ring (1);
rolling bodies (3) positioned between said inner ring (2) and said outer ring (1) and contacting said inner ring (2) and said outer ring (1);
wherein said outer ring (1) has two oppositely positioned contact points (7, 8) for each one of said rolling bodies (3) on which contact points (7, 8) said rolling bodies (3) are supported, respectively, wherein said contact points (7, 8) are configured such that a contact angle of said rolling bodies (3) is at least approximately independent of a rotational speed of a rotary part supported by said high-speed rolling bearing.

2. The high-speed rolling bearing according to claim 1, wherein said outer ring (1) has an inner surface with a rolling body race (6), wherein said contact locations (7, 8) are arranged such that a position of said rolling body race (6) is virtually rotational speed-independent and force-independent.

3. The high-speed rolling bearing according to claim 1, wherein said rolling bodies (3) contact said inner ring (2) at one contact location of said inner ring (2), respectively.

4. The high-speed rolling bearing according to claim 1, wherein said rolling bodies (3) contact said inner ring (2) at two oppositely positioned contact locations (9, 10) of said inner ring (2), respectively.

5. The high-speed rolling bearing according to claim 4, wherein said inner ring (2) is comprised of a first inner ring half (11) and a second inner ring half (12), wherein a first one of said two oppositely positioned contact locations (9) is provided on said first inner ring half (11) and a second one of said two oppositely positioned contact locations (10) is provided on said second inner ring half (12).

6. The high-speed rolling bearing according to claim 1, wherein said rolling bodies (3) are balls.

7. The high-speed rolling bearing according to claim 1 embodied as an angular ball bearing.
